(19) United States
(12) Patent Application Publication
(10) Pub. No.: US 2007/0005768 A1
(43) Pub. Date: Jan. 4, 2007

(54) Method and system for providing streaming service in home network

(75) Inventors: Jong-eun Won, Seoul (KR); Jung-yon Cho, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/476,628

(22) Filed: Jun. 29, 2006

(30) Foreign Application Priority Data
Jun. 29, 2005 (KR) 10-2005-0057311

(51) Int. Cl. G06F 15/173

(52) U.S. Cl. 709/225

(57) ABSTRACT

A method and system for providing a streaming service in a home network. The method includes requesting a streaming service and transmitting information about the priority of the request to the server, and connecting to the server, which selectively disconnects the connection of a client that has a priority lower than that of the transmitted request, depending on whether the requested streaming service is available, and receiving the requested streaming service.

### CROSS-REFERENCE TO RELATED APPLICATIONS

This application claims priority from Korean Patent Application No. 10-2005-0057311 filed on Jun. 29, 2005 in the Korean Intellectual Property Office, the disclosure of which is incorporated herein by reference in its entirety.

### BACKGROUND OF THE INVENTION

1. Field of the Invention

Methods and systems consistent with the present invention relate generally to providing a streaming service and, more particularly, to providing a streaming service in a home network, which, when a new streaming connection cannot be provided by a server, allows a priority between an existing connection and a new connection to be determined, thus providing reasonable connection management.

2. Description of the Related Art

A media server, which plays a role of providing various types of content to different clients via a network, must simultaneously provide a streaming service to a plurality of media clients according to different situations. In this case, the number of streaming connections that can be simultaneously provided by the server may be limited depending on the processing power of a server, the bandwidth of the network, or the like. In an existing streaming service, when a situation in which a new connection cannot be provided occurs, a method in which the server rejects a new connection service request has been used.

FIG. 1 is a diagram illustrating a related art method of providing a streaming service in a home network.

Referring to FIG. 1, a server 110, which provides digital content, and one or more clients, that is, first, second and third clients 121 to 123, each of which requests a streaming service from the server, are connected over a network. The first, second and third clients may exist in different devices or in a single device. Each of the clients transmits a service request to the server 110 requesting desired content from the server. The server provides the content to the corresponding client in a streaming manner in response to the request.

When the first client 121 transmits a service request 131 for a specific media file to the server 110, the server 110 transmits data about the requested content to the first client 132. That is, the server 110 provides a streaming service to the first client 121. The second client 122 transmits a service request 133 for a specific media file to the server 110, the server 110 determines whether service can be provided based on the service capability thereof (processing power, network bandwidth, etc.), and provides a streaming service to the second client when it is determined that the service can be provided 134. When the third client 123 transmits a service request 135 for a specific media file to the server 110, the server 110 determines whether service can be provided according to the service capability thereof. If it is determined that a new service cannot be provided, the service request from the third client is rejected 136.

However, the above-described method is problematic in that whether service can be provided is determined by the order of the service requests without considering the degrees of importance of the service requests from the clients, and therefore an important service request cannot be given priority. Furthermore, in the case where the server is a source that provides a single service connection, such as a Compact Disc (CD), a Digital Video Disc (DVD) or a tuner, and a user desires to be continuously provided with the same service while moving within a home, a problem occurs in that the new service connection is limited due to an existing service connection.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method and system for providing a streaming service, which provides a user interface that allows a user to set the priority of a service request, thus being capable of carrying out the user's service request prior to an existing connection.

According to an aspect of the present invention, there is provided a method of providing a streaming service in a home network, including: requesting a streaming service and transmitting information about the priority of the request to the server; and connecting to the server, which selectively disconnects the connection of a client that has a priority lower than that of the transmitted request, depending on whether the requested streaming service is available, and receiving the requested streaming service.

According to another aspect of the present invention, there is provided a method of providing a streaming service in a home network, including receiving a streaming service request and information about the priority of the request from a first client; selectively disconnecting the connection of a second client that transmitted a request having a priority lower than that of the received request, depending on whether the requested streaming service is available; and transmitting streaming data to the first client.

According to another aspect of the present invention, there is provided a client for a system for providing a streaming service in a home network, including a means for transmitting a streaming service request and information about the priority of the request to a server; a means for selectively connecting to a server, which selectively disconnects a connection with a client that transmitted a request having a priority lower than that of the transmitted request, depending on whether the requested streaming service is available, and receiving the requested streaming service.

According to another aspect of the present invention, there is provided a server for a system for providing a streaming service in a home network, including a means for receiving a streaming service request and information about the priority of the request from a first client; a means for selectively disconnecting the connection of a second client that has a priority lower than that of the received request, depending on whether the requested streaming service is available; and a means for transmitting streaming data to the first client.

### BRIEF DESCRIPTION OF THE DRAWINGS

The above and other aspects of the present invention will be more clearly understood from the following detailed description of exemplary embodiments taken in conjunction with the accompanying drawings, in which:

FIG. 1 is a diagram illustrating a related art method of providing a streaming service in a home network;

FIG. 2 is a schematic diagram illustrating a method of providing a streaming service in a home network according to an exemplary embodiment of the present invention;

FIG. 3 is a diagram showing a message employed when a client of a system for providing a streaming service in a home network requests a service according to an exemplary embodiment of the present invention;

FIG. 4 is a block diagram showing the construction of a system for providing a streaming service in a home network according to an exemplary embodiment of the present invention;

FIG. 5 is a flowchart illustrating an operational process of the client of a system for providing a streaming service in a home network according to an exemplary embodiment of the present invention;

FIG. 6 is a flowchart illustrating an operational process of the server of a system for providing a streaming service in a home network according to an exemplary embodiment of the present invention; and

FIG. 7 is a status diagram showing a connection between the server and client of a system for providing a streaming service in a home network according an exemplary embodiment of the present invention.

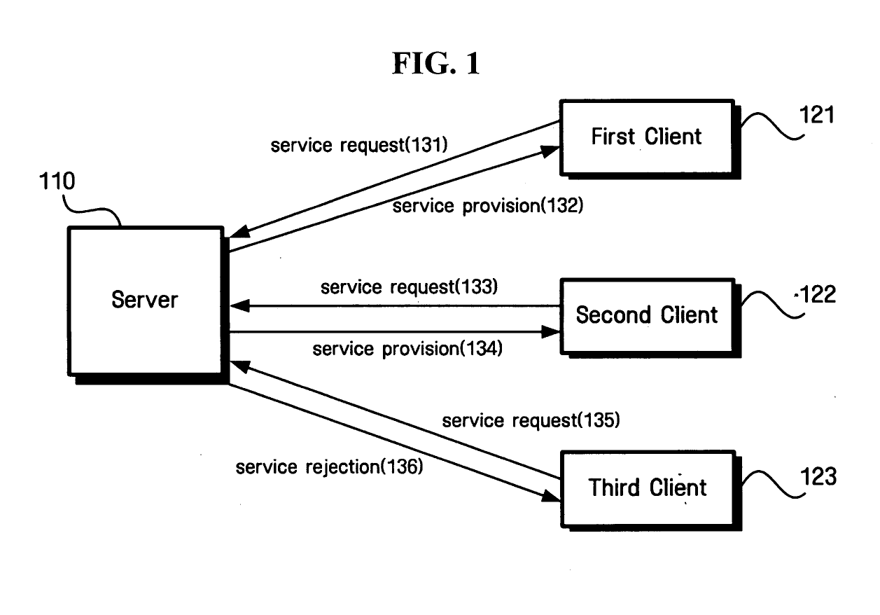

### DETAILED DESCRIPTION OF THE EXEMPLARY EMBODIMENTS

The advantages and characteristics of the present invention, and a method of achieving them, will become apparent with reference to exemplary embodiments described in detail later in conjunction with accompanying drawings. However, the present invention is not limited to the exemplary embodiments disclosed below, but may be implemented in various ways. Furthermore, the exemplary embodiments are provided to complete the disclosure of the present invention, and to fully notify those skilled in the art of the scope of the present invention. The present invention is defined only by the appended claims. The same reference numerals are used throughout the different drawings to designate the same or similar components.

A exemplary embodiment of the present invention is described in detail below with reference to the accompanying drawings.

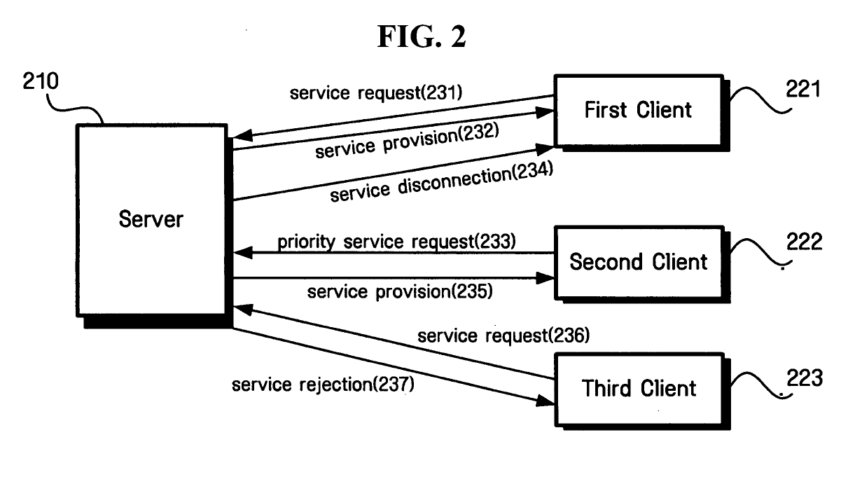

FIG. 2 is a conceptual diagram illustrating a method of providing a streaming service in a home network according to an exemplary embodiment of the present invention.

When a first client 221 transmits a service request 231 for a specific media file to a server 210, the server 210 provides the streaming service of corresponding data 232 to the first client 221. A second client 222 transmits a priority service request 233 for specific content to the server 210. In the case where the server 210 reaches its service-providing limit, the server 210 compares the priority of the service request of the second client 222 with the priority of the existing connection. In this case, the server 210 disconnects the existing connection with the first client 221 if the priority of the new service request is higher than that of the existing connection 234. When a function of disconnecting the connection with the first client 221 is successively performed, the server 210 provides a streaming service to the second client 235. When a third client 223 transmits a service request for specific content 236 to the server 210, the server 210 determines the service capability thereof. In the case where it is determined that the requested service cannot be provided, the server 210 rejects the service request 237 from the third client 223. In this case, the service request from the third client is not a high-priority service request, and therefore the server 210 cannot disconnect the service connection of the second client.

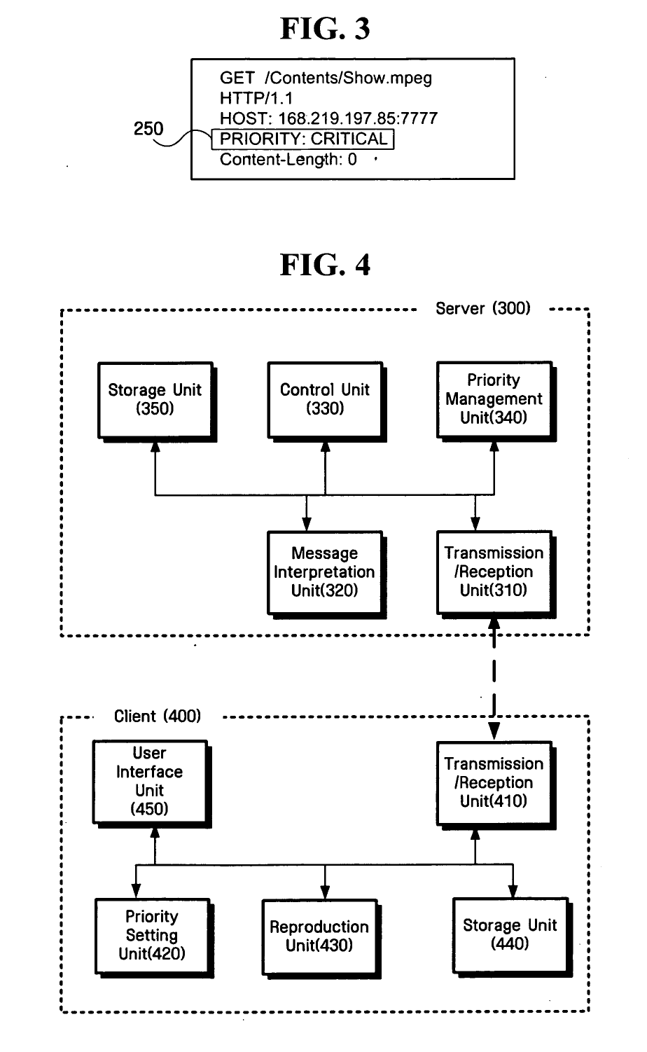

An example of a message employed when a client of a system for providing a streaming service in a home network according to an exemplary embodiment of the present invention requests a service having a priority is described with reference to FIG. 3.

In the case where a home network supporting Universal Plug and Play (UPnP), Digital Living Network Alliance (DLNA) or the like is used, a HyperText Transfer Protocol (HTTP) Get message may be used as an exemplary embodiment of the service request of each client. The exemplary embodiment of FIG. 3 adds a header 250, which indicates the priority of the service request, to the HTTP Get message and informs the server of the priority of the service request employing the message. Priorities may be variously classified according to a method of implementing the home network-based streaming system and a priority management policy. Hereinafter, for easy of description, a description is made under the assumption that the priorities are classified into three levels.

For example, the priorities of the streaming system according to the present exemplary embodiment are classified into three levels, that is, a normal priority level, a critical priority level and a forced level of priority. The normal priority level is the lowest priority level, the forced priority level is the highest priority, and the critical priority level is a priority higher than that of the normal level and lower than that of the forced level. In the case where a user requests a service without assigning a priority (reference numerals 231 and 236 of FIG. 2), the server 210 assigns the corresponding service request a normal priority level rating. A service request having a forced priority level, which is the most urgent service request, has the highest priority that can disconnect any existing service connection. When a single client performs a service request having the forced priority level and is then successfully connected to the server, the priority of the client is subsequently lowered to the critical priority level. This is to guarantee the provision of unconditional service in the case where a service request having the forced priority level is subsequently received from another client.

The service request of an existing system, in which the priority streaming service method according to an exemplary embodiment of the present invention is not adopted, corresponds to a service request in which a priority is not specified, thus being capable of being processed as a priority service request having a normal priority level or a critical priority level according to the service provision policy of the server.

FIG. 4 is a block diagram showing the construction of a system for providing a streaming service in a home network according to an exemplary embodiment of the present invention.

The server 300 of the system for providing a streaming service in a home network according to an exemplary embodiment of the present invention may include a transmission and reception unit 310, a message interpretation unit 320, a priority management unit 340, a control unit 330, and a storage unit 350.

The transmission and reception unit 310 receives a service request message from the client 400 and transmits streaming data corresponding to the service request thereto. The message interpretation unit 320 interprets the service request message received from the transmission and reception unit 310 and extracts information about the priority of the service request therefrom.

The control unit 330 determines whether service can be provided to the client 400, based on the processing capability of the server, the bandwidth of a network and the like, and controls the operations of the transmission and reception unit 310, the message interpretation unit 320, the priority management unit 340 and the storage unit 350.

If, as the result of the determination of the control unit 330, a new connection cannot be accepted based on the current capability of the server, the priority management unit 340 compares the priority of a new service request, which is provided from the message interpretation unit 320, with the priority of the connection of an existing client to which service is already being provided. When a service connection having a priority lower than that of the new service request exists, the priority management unit 340 disconnects the service connection having the lower priority and creates a connection with the client that made the new service connection request. In contrast, when a service connection exist that has a priority higher than that of new service request, the server 300 rejects the new service request.

When the priority of the new service request is a forced priority level, the server 300 disconnects an existing connection having the lowest priority without engaging the process of comparing priorities and creates a connection with the corresponding client, thus being capable of transmitting streaming data thereto. In this case, the priority management unit 340 lowers the priority of the client, for which the connection has been created, to the critical priority level.

The storage unit 350 stores content data for a media service that is provided by the server 300 and information about the priorities of clients currently connected to the server.

The client 400 for the system for providing a streaming service in a home network on according to an exemplary embodiment of the present invention system may include a transmission and reception unit 410, a priority setting unit 420, a reproduction unit 430, a storage unit 440, and a user interface unit 450.

The transmission and reception unit 410 transmits a message requesting a streaming service to the server 300, and receives content data from the server 300.

The user interface unit 450 allows a user to determine whether a user priority setting mode, in which the user can input a priority, is switched, and provides a user interface which receives information about the priority of a service request therethrough.

The priority setting unit 420 inserts information about a priority into the service request message based on the information about the service priority input by the user interface unit 450. In the case where the service is rejected by the server, the priority setting unit 420 automatically increases the priority of the service request by one level.

The storage unit 440 can store the streaming data received through the transmission and reception unit 410. The reproduction unit 430 performs a role of reproducing the streaming data provided from the transmission and reception unit 410 or the storage unit 440.

The components of FIG. 4 may refer to software and hardware, such as Field-Programmable Gate Arrays (FPGAs) or Application-Specific Integrated Circuits (ASICs). The components may be constructed to reside in an addressable storage media, or they may be constructed so as to reproduce one or more processes. The functions provided within the components may be realized by more subdivided components, or an aggregation of the components may be realized as a single component that performs a specific function.

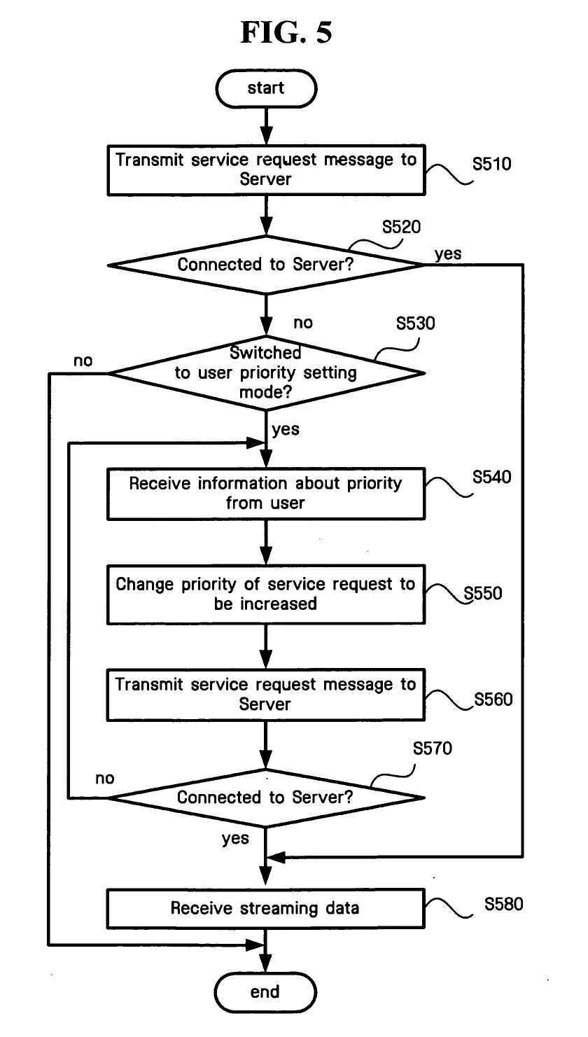

FIG. 5 is a flowchart illustrating an operational process of the client of a system for providing a streaming service in a home network according to an exemplary embodiment of the present invention.

When desired to be provided with a streaming service from the server 300, the client 400, according to an exemplary embodiment of the present invention, transmits a service request message to the server 300 in operation S510. When a connection with the server 300 is created (“Yes” in operation S520), the client 400 receives the streaming data transmitted from the server 300 in operation S580.

When the connection with the server 210 fails (“No” in operation S520), the user interface unit 450 inquires of a user whether to switch into a user priority setting mode in operation S530. When a request to switch into the user priority setting mode is made by the user (“Yes” in operation S530), the user interface unit 450 receives information about the priority of a service request from the user in operation S540, and the priority setting unit 420 changes the priority of the service request based on the information about the priority received in operation S550. The transmission and reception unit 410 transmits a service request message, including information about a changed priority, to the server 300 in operation S560. The client 400 may repeatedly perform the operations of S540 to S570 until the connection with the server 300 succeeds. When the connection with the server 300 is established (“Yes” in operation S570), the client 400 receives the streaming data from the server 300 through the transmission and reception unit 410 in operation S580.

In contrast, when the user does not conduct switching into the user priority setting mode (“No” in operation S530), the client 400 terminates the service request. That is, the streaming service system, according to an exemplary embodiment of the present invention, provides a user interface so that the user can select whether to give up on his or her service request, or whether to disconnect the service connection of another client. Accordingly, the system, according to an exemplary embodiment of the present invention, allows the user to make a general service request, the priority of which is not considered at the early stage, and allows the user to attempt a service request on a priority basis if the general request has failed.

The client, according to another exemplary embodiment of the present invention, does not provide the user priority setting mode, and can automatically request service while increasing the priority of a service request by one level if the connection with the server has failed.

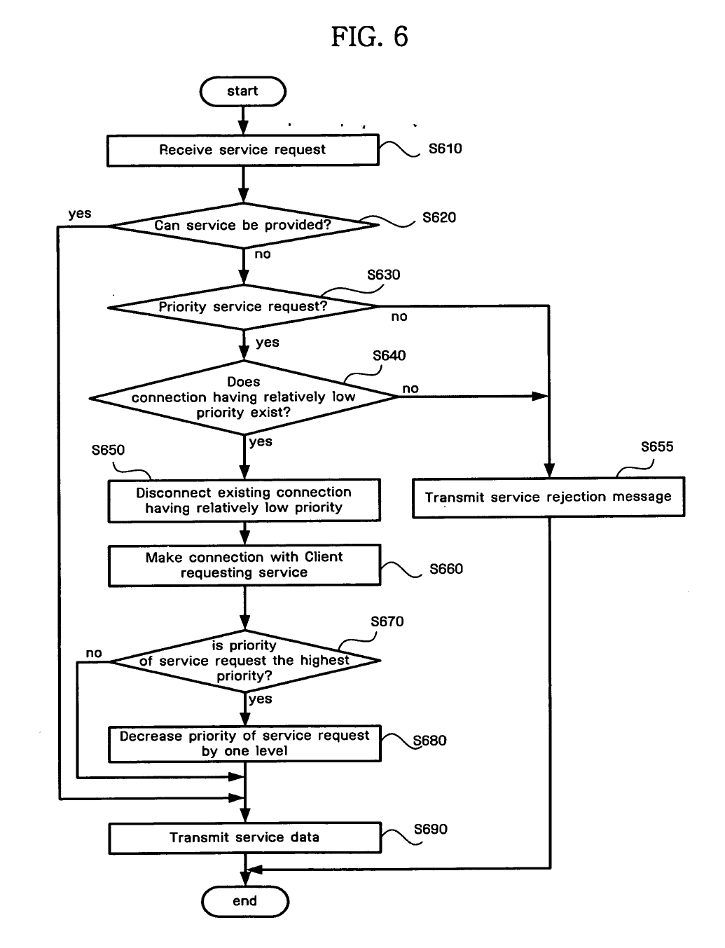

FIG. 6 is a flowchart illustrating an operational process of the server of a system for providing a streaming service in a home network according to an exemplary embodiment of the present invention.

When receiving a service request from the client 400 in operation S610, the server 300, according to an exemplary embodiment of the present invention, determines whether to accommodate a new service request based on the service capability of the server 400 in operation S620. If the new service request exceeds the service capability of the server 400 (“No” in operation S620), the server 300 determines whether the new service request is a priority service request in operation S630. If the new service request is a priority service request (“Yes” in operation S630), the server 300 performs a search to determine whether an existing service connection having a lower priority exists in operation S640. If the existing service connection having the lower priority exists (“Yes” in operation S640), the existing service connection having the lower priority is disconnected in operation S650, and a connection with the client that made the new service request is established in operation S660.

In contrast, if the new service request is not a priority service request (No in operation S630), or if the existing connection having the lower priority does not exist (“No” in operation S640), the server 300 transmits a service rejection message to the corresponding client in operation S655.

If the priority of the new service request is highest, for example, a forced priority level (“Yes” in operation S670), the server 300 changes the priority to decrease by one level, that is, a critical priority level, in operation S680, and transmits service data to the client in operation S690.

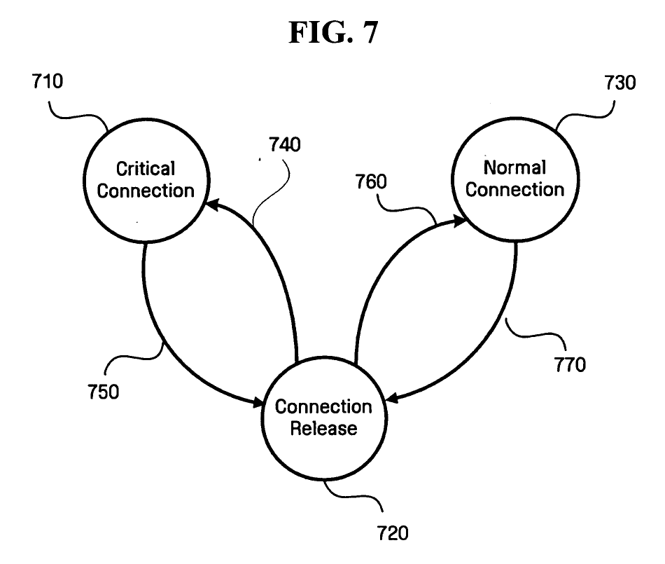

FIG. 7 is a status diagram showing a connection between the server and client of a system for providing a streaming service in a home network according an exemplary embodiment of the present invention.

In the case where priorities are classified into three levels, that is, a normal priority level, a critical priority level, and a forced priority level, the connection status between the server and the client may be one of a critical connection 710, a normal connection 730, and a connection release 720. A forced priority level is the highest priority, and can be chosen by a user who desires to receive a service, prior to the existing connection. Accordingly, the forced priority level does not directly correspond to the connection status between the server and the client.

When the client makes a priority service request 740, the connection release status 720 is switched into the critical connection status 710. When the client makes a service request having no priority or makes a service request 760 having a normal priority level, the connection release status 720 is switched into a normal connection status 730. When another client makes a service request having a forced priority level or the service is completed 750, the critical connection status 710 is switched into the connection release status 720. When another client makes a service request having a critical priority level or a service request having a forced priority level, or the service is completed 750, the normal connection status 730 is switched into the connection release status 720.

In accordance with the method and system for providing a streaming service according to the present invention, one or more effects can be achieved as follows.

First, the service request of a client connected to a server through a home network is managed according to the degrees of importance, so that an efficient streaming service can be implemented.

Second, a user interface, which allows a user to set the priority of a service request, is provided, so that a streaming service can be received prior to an existing connection.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of providing a streaming service in a home network, the method comprising:
transmitting to a server a request for a streaming service and information about a priority of the request; and
connecting to the server and receiving the streaming service from the server if the server determines that the priority of the request is higher than a priority of an existing service connection.

2. The method of claim 1, further comprising providing a user interface for changing the information about the priority depending on whether the request for the streaming service has been connected,
wherein the transmitted information about the priority is information about a priority changed through the user interface.

3. The method of claim 2, further comprising changing the information about the priority according to the information about the priority received through the user interface.

4. The method of claim 2, wherein the user interface receives at least one of information about whether to change the priority of the request for the streaming service and information about a priority desired to be changed from a user.

5. The method of claim 2, wherein the home network supports at least one of Universal Plug and Play and Digital Living Network Alliance.

6. The method of claim 2, wherein the user interface receives at least one of information about whether to change the priority of the request for the streaming service and information about a priority desired to be changed.

7. The method of claim 1, wherein the home network supports at least one of Universal Plug and Play and Digital Living Network Alliance.

8. A method of providing a streaming service in a home network, the method comprising:
receiving from a first client a request for a streaming service and information about a priority of the request;
determining whether the priority of the request received from the first client is higher that a priority of a connection of a second client; and
disconnecting the connection of the second client and transmitting streaming data to the first client, if it is determined that the priority of the request received from the first client is higher than the priority of the connection of the second client.

9. The method of claim 8, further comprising changing the priority of the request from the first client to a lower priority if it is determined that the priority of the request received from the first client is higher than the priority of the connection of the second client.

10. The method of claim 8, further comprising transmitting a service rejection message to the first client if it is determined that the priority of the request received from the first client is lower than the priority of the connection of the second client.

11. The method of claim 8, further comprising storing information about the priority of the request received from the first client.

12. The method of claim 8, wherein the home network supports at least one of Universal Plug and Play and Digital Living Network Alliance.

13. A client for a system for providing a streaming service in a home network, the client comprising:
a transmission and reception unit which transmits to a server a request for a streaming service request and information about a priority of the request, and receives the streaming service if the server determines that the priority of the request is higher than a priority of an existing service connection of another client.

14. The client of claim 13, further comprising a user interface unit which provides a user interface for changing the information about the priority depending on whether the request for the streaming service has been rejected,
wherein the transmitted information about the priority is information about a priority that has been changed through the user interface.

15. The client of claim 14, further comprising a priority setting unit which changes the information about the priority according to the information about the priority received through the user interface.

16. The client of claim 14, wherein the priority information received through the user interface is information about a highest priority.

17. The client of claim 14, wherein the user interface unit provides a user interface that receives information about whether to change a priority of the request for the streaming service therethrough, and provides a user interface that receives information about a changed priority of the request for the streaming service.

18. The client of claim 14, wherein the user interface receives at least one of information about whether to change a priority of the request for the streaming service and information about a changed priority of the request for the streaming service.

19. The client of claim 13, wherein the home network supports at least one of Universal Plug and Play and Digital Living Network Alliance.

20. A server for a system for providing a streaming service in a home network, the server comprising:
a transmission and reception unit which receives a request for a streaming service and information about a priority of the request from a first client;
a priority management unit which determines whether the priority of the request received from the first client is higher that a priority of a connection of a second client, and if it is determined that the priority of the request received from the first client is higher than the priority of the connection of the second client, disconnects the connection of the second client and transmits streaming data to the first client via the transmission and reception unit.

21. The server of claim 20, wherein the priority management unit changes the priority of the request received from the first client to a lower priority if it determined that the priority of the request received from the first client is higher than the priority of the connection of the second client.

22. The server of claim 20, wherein the priority management unit transmits a service rejection message to the first client via the transmission and reception unit if it is determined that the priority of the request received from the first client is lower than the priority of the connection of the second client.

23. The server of claim 20, further comprising a storage unit which stores the information about the priority of the first client.

24. The server of claim 20, wherein the home network supports at least one of Universal Plug and Play and Digital Living Network Alliance.

25. A computer-readable storage medium storing a program for executing a method of providing a streaming service in a home network, the method comprising:
transmitting to a server a request for a streaming service and information about a priority of the request; and
connecting to the server and receiving the streaming service from the server if the server determines that the priority of the request is higher than a priority of an existing service connection.

26. A computer-readable storage medium storing a program for executing a method of providing a streaming service in a home network, the method comprising:
receiving from a first client a request for a streaming service and information about a priority of the request;
determining whether the priority of the request received from the first client is higher that a priority of a connection of a second client; and
disconnecting a connection of the second client and transmitting streaming data to the first client, if it is determined that the priority of the request received from the first client is higher than the priority of the connection of the second client.
